(19) United States
(12) Patent Application Publication
(10) Pub. No.: US 2015/0010369 A1
(43) Pub. Date: Jan. 8, 2015

(54) Motor Powered Milling Machine Vice Clamping Actuator For Use With A Milling Machine

(71) Applicant: John Randal Orndorf, Fairborn, OH (US)

(72) Inventor: John Randal Orndorf, Fairborn, OH (US)

(21) Appl. No.: 13/934,170

(22) Filed: Jul. 2, 2013

(51) Int. Cl. F16D 13/22; B23Q 3/10

(52) U.S. Cl. CPC F16D 13/22; B23Q 3/10
USPC 409/64; 192/66.1

(57) ABSTRACT

A motor powered milling machine vice clamping actuator for use with a miffing machine vice having a rotatable shaft includes an elongated housing including an opening in a first end and a second end, a vice shaft receiving socket rotatably disposed within the housing and exposed through the opening for receiving the rotatable shaft of the vice, wherein the vice shaft receiving socket is complementary configured to frictionally engage the vice shaft of the milling machine vice. A motor operably connected to the second end of the housing which is laterally disposed to the vice shaft receiving socket having a drive mechanism which interconnects to the vice shaft receiving socket and an actuator switch operable connects to the motor for controlling direction of the drive mechanism.

### BACKGROUND OF THE INVENTION

1. Field of Invention

The invention relates to the field of milling machines and in particular, a device which aids in the clamping and unclamping of parts to be milled by a milling machine which employs a vice.

2. Prior Art

In the prior art, there exists devices that are advantageous to aid to tighten and loosen members, such as lug nuts. For example, conventional rotary impact wrenches include a clutch within a housing which is in axial alignment with a pistol grip handle (such as drill configuration, e.g. U.S. Pat. No. 2,285,638 to L. A. Amtsberg, issued Jun. 9, 1942, for an “Impact Clutch” and U.S. Pat. No. 6,491,111 to Livingston, issued Dec. 10, 2002 for “Rotary impact tool having a twin hammer mechanism”). These deliver rotary force in a series of impact blows.

The ability to deliver a series of impact blows provides a human operator with an advantage in that the human operator can physically hold the impact wrench while delivering high torque forces in short burst or impacts. This device works well in tightening and loosening lug nuts. It also enables user to apply sporadic impact high torque forces to be applied and allow the tool (e,g, socket) to be held by a normal human being. One improvement attained by such rotary impact tool uses a twin hammer mechanism that includes a housing having a hollow cage or carrier member positioned therein. A pair of hollow hammer members are pivotally positioned relative to the hollow cage or carrier member so the hollow hammer members rotate with the hollow cage or carrier member under drive from an air motor output shaft. An anvil is positioned inside the hollow hammer members and the anvil rotates relative to the hollow hammer members. The anvil includes a forward anvil lug, a rearward anvil lug, and an annular ring positioned intermediate the forward anvil lug and the rearward anvil lug. To facilitate assembly of the anvil through the hollow hammer members, the annular ring can be a reduced diameter annular ring or the sides of a full diameter annular ring could be reduced or narrowed. Positive spacing of the hollow hammer members can be achieved by placing a spacer between the hollow hammer members. Alternatively, positive spacing of the hollow hammer members can be achieved by extending the hollow hammer members over the annular ring on the anvil with a step provided on each of the hollow hammer members to provide clearance for the annular ring on the anvil.

While these prior devices provide utility in some applications, they are not readily applicable for use in milling applications. In such milling operations, employing such type of pistol impact devices would displace the worker too far from the part significantly impeding the ability to handle the workpiece in the vice of the milling machine. In addition, powered devices previously employed were are not precision enough to be used as a milling machine vice. Thus, current milling operations employ conventional manual clamping and unclamping mechanisms which result in repetitive motion by the worker and far too often injury to the user.

It is desired to have an automated impact device which aids the user in milling operations. The invention solves the prior problems and reduces potential for injury from repetitive motion of manually clamping and unclamping a vice used in milling operations as well as decreases set-up difficulty and time.

### SUMMARY OF INVENTION

It is an object to improve milling operations.

It is another object to decrease milling operation time.

It is another operation to reduce risk of injury during milling operations.

It is yet another object to ease operator use of milling machines employing a vice.

It is another object to provide a powered device for actuating a vice in conjunction with a milling machine.

Accordingly, the present invention is directed to a motor powered milling machine vice damping actuator for use with a milling machine vice having rotatable shaft which operably connects to a jaw of the vice. The actuator includes an elongated housing including an opening in a first end and a second end. A vice shaft receiving socket rotatably is disposed within the housing and exposed through the opening in the first end for receiving the rotatable shaft of the vice. The vice shaft receiving socket is complementary configured to frictionally engage an end of the the vice shaft of the milling machine. A motor is operably connected to the second end of the housing which is laterally disposed to the vice shaft receiving socket and has a drive mechanism which interconnects to the vice shaft receiving socket. An actuator switch is operable connected to the motor for controlling direction of the drive mechanism.

The motor is laterally disposed to the vice when the socket is frictionally engaged to the vice shaft. The drive mechanism includes a drive belt operably interconnecting the motor drive shaft and the vice shaft receiving socket. The drive shaft and the socket can be connected to a gear like surface and the belt can be a gear belt.

The motor can preferably be an air powered motor. A computer based controller can be operably connected to the actuator switch for controlling the actuator in accordance with an automated milling operation.

Other advantages and novel features of the present invention will become apparent in the following detailed description of the invention when considered in conjunction with the accompanying drawings.

### BRIEF DESCRIPTION OF THE DRAWINGS

FIG. 1 is a top schematic view of the invention.

FIG. 2 is a top schematic revealing internal components of the invention.

FIG. 3 is a side view of the invention.

FIG. 4 is an end view of the invention.

FIG. 5 shows an internal component of the invention.

FIG. 6 shows still another component of the invention.

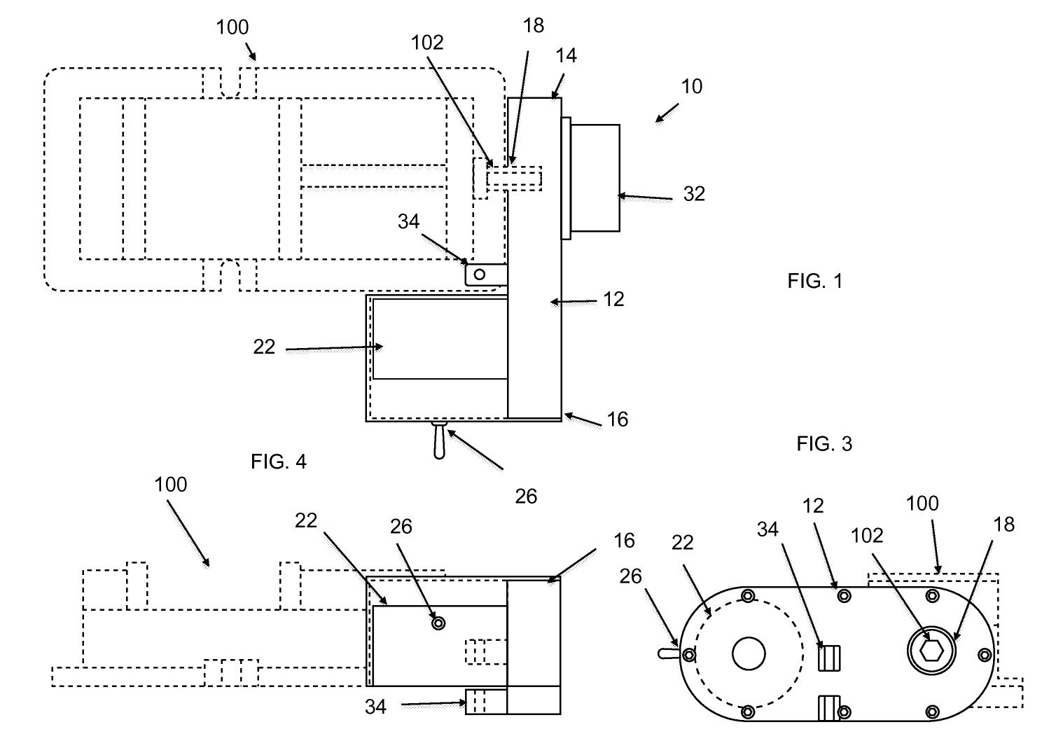

### DETAILED DESCRIPTION OF THE INVENTION

In the following detailed description of preferred embodiments of the present invention, reference is made to the accompanying drawings which, in conjunction with this detailed description, illustrate and describe preferred embodiments of a motor powered milling machine vice damping actuator for use with a milling machine in accordance with the present invention which is generally referenced by the numeral 10. The motor powered milling machine vice clamping actuator 10 is provided for use with a milling machine vice 100. The actuator 10 includes an elongated housing 12 including a first end 14 and a second end 16. The first end 14 includes an opening 18 for receiving a vice shaft 102 therethrough.

A vice shaft receiving socket 20 is rotatably disposed within the housing 12 and exposed through said opening 18 for receiving a conventional hex end of the rotatable shaft 102 of the vice 100. The vice shaft receiving socket 20 is complementary configured to frictionally engage the vice shaft 102 of the milling machine vice 100 which here by way of example is a ¾″ hex end.

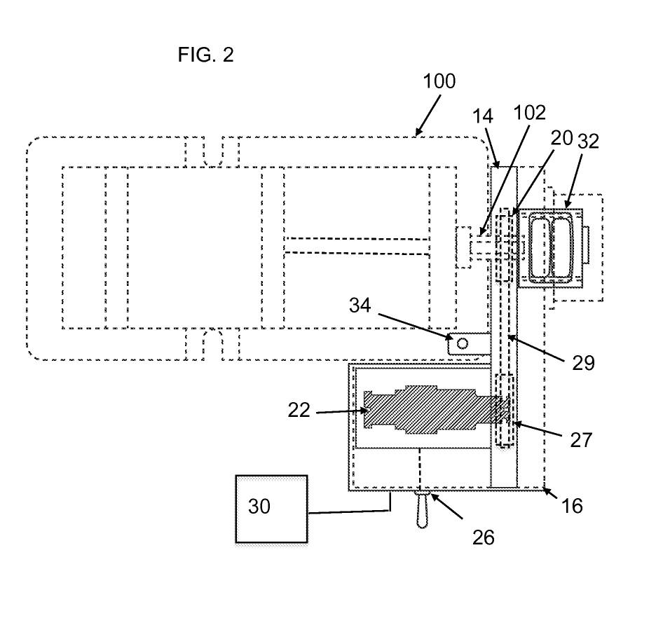

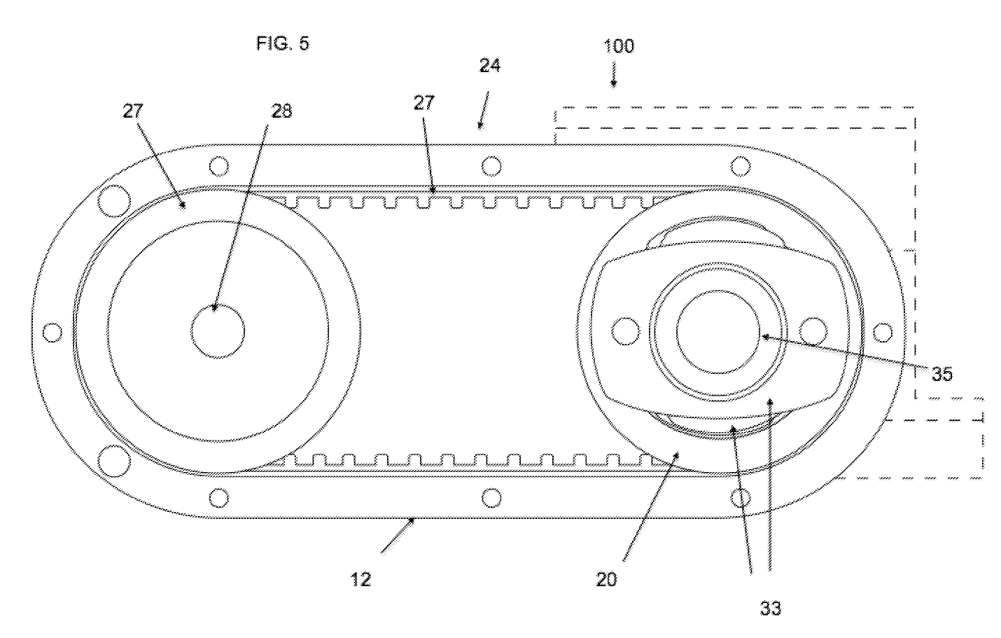

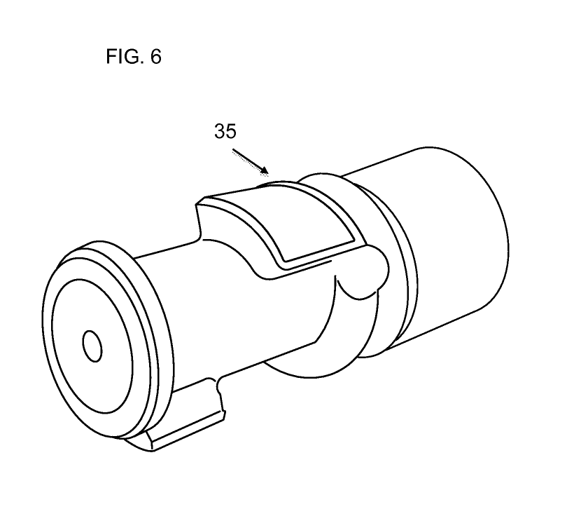

A motor 22 is operably connected to the second end 16 of housing 12 which is laterally disposed to the vice shaft receiving socket 20, and thus providing for the motor 22 to be preferably placed along side the vise 100 (As seen in FIG. 2—a U shaped power drive mechanism). The motor 22 can be preferably be an air motor 22, A drive mechanism 24 interconnects to the vice shaft receiving socket 20. An actuator switch 26 operable connects to the motor 22 for controlling directional operation of the drive mechanism 24. The motor 22 is laterally disposed to the vice 100 when the vice shaft receiving socket 20 is frictionally engaged to the vice shaft 102.

The drive mechanism 24 can include a drive belt 26 operably interconnecting a drive wheel 27 of a motor drive shaft 28 and the vice shaft receiving socket 20. The motor powered milling machine vice damping actuator 10 can include a computer based controller 30 operably connected thereto for controlling the actuator switch 26 in accordance with an automated milling operation. The drive wheel 27 of shaft 28 and the socket 20 can be gear connected to a gear like surface of drive belt 29.

Operably connected to the vice shaft receiving socket 20 is a hammer and anvil impact mechanism 32 which includes parts 33, 35. The impact mechanism 32 provides for a repetitive impact to the vice shaft 102. One or more clamps 34 can be provided to fix the actuator 10 in position relative to the vice 100.

### Relationship Between The Components:

The motor (22) is connected to the drive mechanism 24 (e.g., belt or gearbox). The actuator switch (26) is mounted in the housing (12). The clamp(s) (34) are attached to the housing (12).

The actuator 10 is placed on 3/4 inch hex portion of shaft 102 of mill vice 100. The clamp(s) 34 is then attached to a perimeter of the vice 100. When the switch 26 is actuated, the motor 22 turns the gears 24, 20 and the impact mechanism 32 in the housing 12 and closes the vice jaws 104. When the switch 26 is actuated in the opposite direction, the motor 22 turns the gears 20, 24 and the impact mechanism 32 in the gearbox housing 12 and opens the jaws 104.

The housing 12 can be fabricated to accept the custom gears, impact mechanism, motor and switching device and internal provision to connect the motor and switching device will be incorporated in the housing 12. A remote pushbutton instead of the housing mounted switch could add more options on how to actuate the motor.

Push the actuator 10 on the ¾″ hex shaft 102 of the vice 100. Attach the clamp 34 of the housing 12 and then to the mill vice perimeter. Hook up power to the motor 22 and actuate 26 the switch to open or close the vice 100. The components of the invention can be fabricated of metal, such as aluminum or plastic and or rubber.

Accordingly, although the present invention has been described above in detail, the same is by way of illustration and example only and is not to be taken as a limitation on the present invention. It is apparent to those having a level of ordinary skill in the relevant art that other variations and modifications in a rotary impact tool having a twin hammer mechanism in accordance with the present invention, as described and shown herein, could be readily made using the teachings of the present invention. The scope and content of the present invention are to be defined only by the terms of the appended claims.

What is claimed is:

1. A motor powered milling machine vice damping actuator for use with a milling machine vice having a rotatable shaft, which includes:
an elongated housing including an opening in a first end and a second end;
a vice shaft receiving socket rotatably disposed within said housing and exposed through said opening for receiving the rotatable shaft of the vice, wherein said vice shaft receiving socket is complementary configured to frictionally engage the vice shaft of the milling machine vice;
a motor operably connected to said second end of said housing which is laterally disposed to the vice shaft receiving socket having a drive mechanism which interconnects to said vice shaft receiving socket; and
an actuator switch operable connected to said motor for controlling direction of said drive mechanism.

2. The motor powered milling machine vice damping actuator of claim 1, wherein said motor is laterally disposed to the vice when said socket is frictionally engaged to said vice shaft.

3. The motor powered milling machine vice damping actuator of claim 1, wherein said drive mechanism includes a drive belt operably interconnecting said motor drive shaft and said vice shaft receiving socket.

4. The motor powered milling machine vice clamping actuator of claim 1, wherein said motor is an air powered motor.

5. The motor powered milling machine vice clamping actuator of claim 4, which includes a computer based controller operably connected to said actuator for controlling said actuator switch in accordance with an automated milling operation.

6. The motor powered milling machine vice damping actuator of claim 1, which includes a computer based controller operably connected to said actuator for controlling said actuator switch in accordance with an automated milling operation.

7. The motor powered milling machine vice damping actuator of claim 3, wherein said drive shaft and said socket are connected to a gear like surface and said belt is a gear belt.

8. The motor powered milling machine vice damping actuator of claim 1, which includes a mounting bracket for mounting to the vice.

9. The motor powered milling machine vice damping actuator of claim 1, which has provides a U-shaped drive mechanism with said motor having a drive shaft in parallel relation to the rotatable shaft of the vice when operably disposed adjacent thereto.
